(19) United States
(12) Patent Application Publication
(10) Pub. No.: US 2005/0250403 A1
(43) Pub. Date: Nov. 10, 2005

(54) Mat made from natural fibres and glass

(75) Inventors: Michel Droux, La Ravoire (FR); Francois Roederer, Chambery (FR); Francois Vinet, Chambery (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Saint-Gobain Vetrotex France S.A., Chambery (FR)

(21) Appl. No.: 10/504,152

(22) PCT Filed: Feb. 27, 2003
(86) PCT No.: PCT/FR03/00631

§ 371 Date: Jun. 24, 2005

(30) Foreign Application Priority Data
Feb. 27, 2002 (FR) 02/02463

(51) Int. Cl. B32B 17/02

(52) U.S. Cl. 442/180; 442/402

(57) ABSTRACT

The invention relates to a mat comprising discontinuous natural fibers and discontinuous glass fibers, and to the fibrous structures that can be produced using said mat, said structures being intended to reinforce composites. The presence of natural fibers in the mat gives the latter the property of being easy to handle, especially by eliminating the annoying tendency of mats made exclusively of glass fiber to wrinkle uncontrollably. In addition, the mechanical properties of the final composite are remarkable, in particular with regard to the tensile modulus and flexural modulus.

The invention relates to a mat comprising discontinuous natural fibers and discontinuous glass fibers, and to the fibrous structures that can be produced using said mat.

The production of a fiber-reinforced composite comprises the forming, in a mold, of a fibrous structure such as a mat and then the injection of a polymer-based resin in order to impregnate said structure. The resin is then solidified by crosslinking (in the case of thermosetting resins) or by cooling (in the case of thermoplastic resins). The fibrous structure must consequently have a number of properties. In particular, before impregnation, it must have good drapability, that is to say it must let itself be easily shaped and therefore easily deformed by hand, without any tendency to wrinkle. It is also desirable for the structure to exhibit shape memory, that is to say that it retains the shape that it has been given, for example by hand, deforming as little as possible under the effect of its own weight. For a given mass per unit area, it must also be as permeable as possible to the impregnation resin and must reinforce the final material as much as possible. In particular, for some applications such as, for example, a rear-window shelf of a motor vehicle, the aim is for the final composite to have a high flexural modulus and a high tensile modulus. Preferably, the final composite is as light as possible and therefore has a low density. Advantageously, the final composite is as homogeneous as possible (symmetry of the properties), which depends directly on the homogeneity of the initial fibrous structure.

The use of crimped polypropylene fibers has been proposed in EP-0 745 716, EP 0 659 922 and EP 0 395 548 for making fibrous reinforcing structures. However, for a number of applications, polypropylene fiber, which is relatively expensive, does not have sufficient reinforcing properties and also does not allow itself to be easily wetted and impregnated by thermosetting resins such as polyesters. The use of other fibers that have superior mechanical properties and/or allow themselves to be better impregnated is therefore desirable. Moreover, it is also desirable to be able to use uncrimped fibers, owing to the fact that crimping represents an additional step and also that it is not always possible to produce a crimp on a fiber, especially a glass fiber.

As other documents of the prior art, mention may also be made of WO 96/27039, WO 96/13627, and EP 0 694 643.

Within the context of the present invention the term “mat” refers to a bonded nonwoven. Such a mat has sufficient cohesion to be able to be manipulated by hand without losing its structure. It possesses this cohesion because it is bonded, generally by chemical means (using a chemical binder) or by mechanical means, such as needle punching or stitching.

According to the invention, discontinuous natural fibers and discontinuous glass fibers are combined in the same mat. The mat according to the invention (which can be called a “hybrid” mat) may, for example, be such that the fibers of which it is composed comprise from 10 to 90%, and more particularly 30 to 70%, by weight of natural fibers. The mat according to the invention may, for example, be such that the fibers of which it is composed comprise from 10 to 90%, and more particularly 30 to 70%, by weight of glass fibers. The mat according to the invention may be such that the fibers of which it is composed are exclusively a mix of natural fibers and glass fibers. In particular, the mat should not contain elements incompatible with the resin with which it will be impregnated. Thus, if the mat has to be impregnated with a thermosetting resin, it is preferable for the mat not to contain a polyolefin.

Within the mat according to the invention, the two types of fiber are distributed homogeneously, which means that no gradient in one of the types of fiber is observed in the thickness of the mat.

The natural fibers may, for example, be flax or hemp or sisal or jute fibers. They are naturally discontinuous and generally have lengths ranging from 10 to 150 cm before conversion by the process according to the invention. The process according to the invention, when the fibers are bonded by mechanical means, tends to shorten the fibers somewhat. This is why, in the mat according to the invention, the natural fibers generally have a length of less than 150 cm.

The natural fibers may have been pretreated, then treated so as to improve their adhesion to the matrix of the final composite. These treatments, which are themselves conventional, are similar to the sizing treatments in the case of glass fibers, but with processes and formulations that are specific to natural fibers. It is also possible for the natural fibers not to have been treated (nor pretreated, of course).

The glass fibers may have a diameter ranging from 5 to 25 μm and a length ranging from 10 mm to 200 mm, for example about 25 mm or 50 mm or 100 mm. The discontinuous glass fibers are generally chopped from continuous fibers assembled into strands.

The glass fibers may be unsized or may be sized, or may have been desized.

It was found that the presence of natural fibers in the mat gave the mat the property of being easily handled, especially by eliminating the annoying tendency of mats made exclusively of glass fiber to wrinkle uncontrollably along lines in the plane of the mat passing entirely through it, as occurs when board is folded. This improvement in the behavior is probably due to the intimate mixing of the two types of fiber within the same layer (homogeneous distribution in the mat). For a given mat weight per unit area, it was also found that the mechanical properties of the final composite were remarkable, particularly as regards the tensile modulus and flexural modulus.

The mat according to the invention generally has a weight per unit area ranging from 100 to 900 g/m², for example about 300 g/m² or about 450 g/m² or about 600 g/m².

To produce the mat according to the invention, the fibers are laid down by a dry-having loft process of the type well known to those skilled in the art.

The final mat has the property of having loft, that is to say it can be easily compressed between the fingers with a spring effect (a veil does not have this property at all).

The mat according to the invention may be bonded by chemical means or by mechanical means, such as needle punching. The mat according to the invention is obtained using conventional mat-manufacturing techniques. When the mat is bonded by mechanical means, its manufacturing process uses conventional 30 felt-manufacturing techniques. In particular, the following succession of steps may be carried out:
production of a glass fiber/natural fiber premix using a fiber opener; then
production of a homogeneous glass fiber/natural fiber mix using a fiber opener; then
production of a web, by carding/web-forming; and then
consolidation of the web by mechanical needle punching on both faces of the latter.

The fiber opener may especially be of the Laroche No. 1 type.

The settings for the mechanical needle punching may, for example, be:
needle penetration: 5 to 30 mm, for example 8 mm,
needle density: 10 to 100 punches per cm², for example 50 to 70 punches per cm².

The process for producing the mat preferably uses tooling for separating the fibers within the final composite, even if strands combining a plurality of fibers are used at the start. The term “strand” is understood to mean an assembly of contiguous fibers, comprising more particularly from 10 to 300 fibers. The function of an opener is especially to separate the fibers of a strand.

The invention relates especially to a mat whose fibers are separated, said mat undergoing a carding/web-forming step followed by needle punching.

The mat according to the invention may by itself constitute the entire fibrous structure to be impregnated. However, the mat according to the invention may also be used to form part of a fibrous structure of which one of the layers is formed by said mat. Thus, the invention also relates to a fibrous structure comprising several fabric layers, at least one of which is the mat according to the invention. At least one other layer of the fibrous structure may be a continuous-strand mat, for example of the type sold under the brand name Unifilo®, or a chopped-strand mat.

The various layers of the structure according to the invention may be linked together by at least one mechanical and/or chemical means. The term “mechanical means” is understood to mean stitching or needle punching. In general, the mechanical means passes through all the superposed layers, such that all the layers are linked together in a single step, for example a stitching step or a needle-bonding step. The term “chemical means” is understood to mean a binder. The binder may bond together the various fabric layers in pairs, that is to say all the pairs of two juxtaposed layers in the structure. The binder may be used in the form of a powder or in liquid form or in the form of a film interposed between the various layers of the structure.

The mat according to the invention or the fibrous structure comprising the mat according to the invention may be impregnated with a resin within the context of the manufacture of a composite. The invention also relates to a composite comprising a mat or a fibrous structure, and a matrix comprising a polymer, especially a thermosetting resin such as a polyester.

In the examples that follow, the mechanical properties of the composites are characterized according to the following standards:
Three-point bending: ISO 141251;
Tension: ISO 527-2.

### EXAMPLES

Three mats, all having a mass per unit area of 300 g/m², were produced, one comprising 100% by weight of flax fibers, another composed of 100% by weight of glass fibers and the last one composed of 50% by weight of glass fibers and 50% by weight of flax fibers. The sized glass fiber was chopped to 50 mm from a strand with the reference name P243 sold by Saint-Gobain Vetrotex. The manufacture of the mats followed the following steps:
passage of the fibers into a Laroche No. 1 fiber opener; then
production of a web by carding/web-forming; and then
consolidation of the web by mechanical needle punching on both faces of the latter.

These mats should therefore have owed their consistency only to the fibers being mechanically linked together, caused by the needle punching (no “chemical” binder).

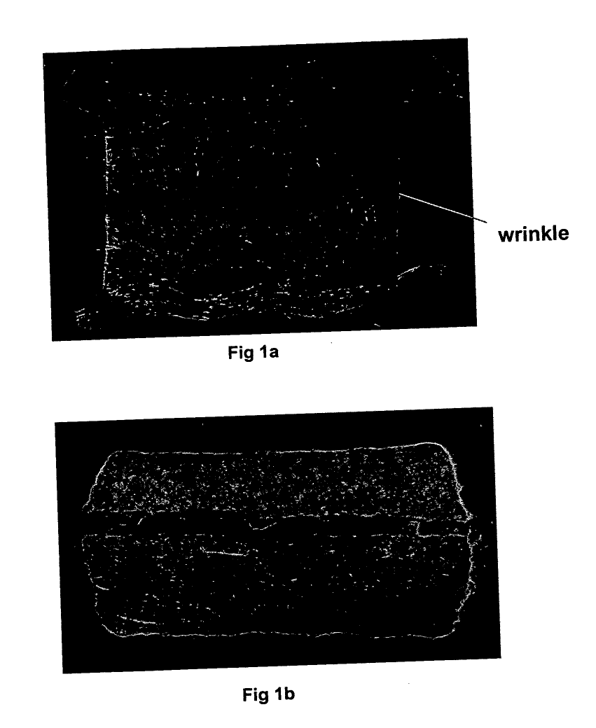

To carry out the shape memory test, squares of 250 mm a side were then cut from the mat obtained. Manually graspring two of the parallel sides, it was attempted to form a tube from each of the mat squares. The mat was then released and its behavior observed. It was found that the 100% flax mat had no integrity, therefore no shape memory. It was found that the 100% glass mat exhibited good retention of the shape that it had been given, but uncontrolled wrinkling occurred (see FIG. 1a). The 50/50 natural fiber/glass fiber hybrid mat exhibited excellent shape memory and also had no tendency to form wrinkles (FIG. 1b).

The three mats were then impregnated with a polyester resin preparation so as to produce identical specimens, so that it was possible to measure the mechanical properties. The impregnation process was of the resin transfer molding (RTM) type. The polyester resin preparation comprised:
a polyester of brand name Norsodyne I 2984 V sold by Cray Valley;
1% by weight of catalyst of the methyl ethyl ketone peroxide type of the brand name BUTANOX M50 sold by Akzo Nobel; and
0.15% by weight of a 6% cobalt octoate solution, sold under the brand name NL51P by Akzo Nobel, as accelerator.

The impregnation was carried out at 30° C. with an injection pressure of 2 bar, followed by post-curing for 1 h at 70° C.

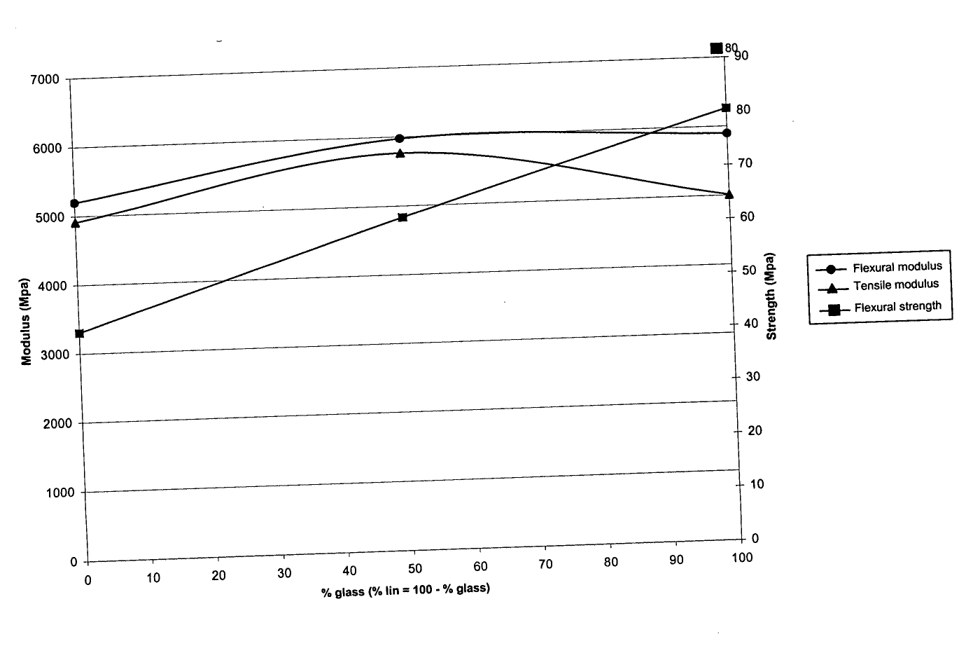

The mechanical properties obtained are given in FIG. 2. Although the flexural strength increases linearly with the glass fiber content, which is normal given the higher intrinsic strength of glass fibers, it may be seen that the tensile and flexural moduli are astonishingly high as regards the use of glass fiber/natural fiber hybrid mats.

1. A mat comprising a homogeneous mix of fibers which is comprised of discontinuous natural fibers and discontinuous glass fibers.

2. The mat as claimed in claim 1, wherein the fibers comprise 10 to 90% by weight of natural fibers.

3. The mat as claimed in claim 2, wherein the fibers comprise 30 to 70% by weight of natural fibers.

4. The mat as claimed in claim 1, wherein the fibers comprise 10 to 90% by weight of glass fibers.

5. The mat as claimed in claim 4, wherein the fibers comprise 30 to 70% by weight of glass fibers.

6. The mat as claimed in claim 1, wherein the fibers consists of glass fibers and natural fibers.

7. The mat as claimed in claim 1, wherein the natural fibers are flax fibers.

8. The mat as claimed in claim 1, wherein the natural fibers have a length of less than 150 cm.

9. The mat as claimed in claim 1, wherein the glass fibers have a length ranging from 10 to 200 mm.

10. The mat as claimed in claim 1, wherein the fibers are mechanically bonded.

11. The mat as claimed in claim 10, wherein the fibers are bonded by needle punching.

12. The mat as claimed claim 11, wherein the fibers are separated, and said fibers are carded and/or web-formed before needle punching.

13. The mat as claimed in claim 1, wherein the mass per unit area of the mat ranges from 100 to 900 g/m².

14. A fibrous structure comprising several fabric layers mechanically and/or chemically linked together, wherein at least one of the layers is the mat as claimed in claim 1.

15. The structure as claimed in claim 14, wherein at least one of the layers is a continuous-strand mat.

16. The structure as claimed in claim 14, wherein at least one of the layers is a chopped-strand mat.

17. A composite material comprising a mat, wherein said mat comprises a homogeneous mix of fibers which comprises discontinuous glass fibers and discontinuous natural fibers, and a matrix comprising a thermosetting resin.

18. The composite material as claimed in claim 17, wherein the resin is a polyester.

19. The composite material as claimed in claim 17, wherein the fibers consists of discontinuous glass fibers and discontinuous natural fibers.

20. The composite material as claimed in claim 17, wherein the mat comprises 10 to 90% by weight of natural fibers and 90 to 10% by weight of glass fibers.

21. The composite material as claimed in claim 20, wherein the mat comprises 30 to 70% by weight of natural fibers and 70 to 30% by weight of glass fibers.

22. The composite material as claimed in claim 20, wherein the only fibrous structure of the composite material is the mat.

23. A process for manufacturing the composite material as claimed in claim 17, comprising
forming the mat in a mold, and then impregnating the mat with a thermosetting resin.
